(19) United States
(12) Patent Application Publication
(10) Pub. No.: US 2020/0389467 A1
(43) Pub. Date: Dec. 10, 2020

(54) METHOD AND APPARATUS FOR SUPPORTING SECURE 5G BY NON-CARRIER ENTITIES

(71) Applicant: Live Planet, Inc., San Carlos, CA (US)

(72) Inventors: Devadutta D. Ghat, Campbell, CA (US); Halsey M. Minor, Beverly Hills, CA (US); Hanno Basse, Santa Monica, CA (US)

(73) Assignee: Live Planet, Inc., San Carlos, CA (US)

(21) Appl. No.: 16/895,804

(22) Filed: Jun. 8, 2020

Related U.S. Application Data
(60) Provisional application No. 62/858,890, filed on Jun. 7, 2019.

(51) Int. Cl. H04L 29/06; H04W 4/24; H04W 24/10; H04L 9/32; H04L 9/30

(52) U.S. Cl. CPC H04L 63/123; H04W 4/24; H04W 24/10; H04W 84/042; H04L 9/3239; H04L 9/30; H04L 9/3247

(57) ABSTRACT

An apparatus, method and system for communicating data between a data source and a client in a cellular communication network is disclosed. The cellular communication network includes a plurality of macro cells controlled by a cellular communication network and a plurality of relay nodes with each relay node controlled by an entity independent from the cellular communication network. The method includes receiving data from the data source in a relay node of the plurality of relay nodes; retransmitting the data from the relay node to the client; computing, in the relay node, a transaction having proof that the data was retransmitted from the relay node to the client; providing the transaction from the relay node to a transaction tracker; and receiving compensation for retransmitting the data from the relay node to the client, the compensation predicated on verification of the computed transaction.

### CROSS-REFERENCE TO RELATED APPLICATIONS

This application claims benefit of U.S. Provisional Patent Application No. 62/858,890, entitled “METHOD AND APPARATUS FOR SUPPORTING SECURE 5G BY NON-CARRIER ENTITIES,” by Devadutta D. Ghat, Halsey M. Minor, and Hanno Basse, filed Jun. 7, 2019, which application is hereby incorporated by reference herein.

### BACKGROUND

### 1. Field

The present disclosure relates to systems and methods for communicating information in a distributed network, and in particular to a system and method for communicating such information by use of non-carrier entities.

### 2. Description of the Related Art

Fifth Generation (5G) is the latest generation of cellular mobile communications which provides high data rate, very low latency, massive machine to machine communication with billions of connected devices in small geographic areas, energy savings, cost reduction and higher system capacity. One of the ways 5G aims to achieve this is with mobile edge computing. Edge computing is a technique of optimizing cloud computing systems by taking the control of computing applications, data, and services away from some central nodes (the “core area”) and instead controlling such applications, data and services closer to the client. In a 5G network, this promotes faster speeds and low-latency data transfer on edge devices.

However, 5G comes with significant technical challenges. 5G networks require approximately ten times the connection density compared to previous generations such as long term evolution (LTE) and 3G. Connection density is the ability to support the successful delivery of a message of a certain size within a certain time, even in space-constrained locations like a football stadium. 5G is expected to support up to 1 million connected devices per 0.38 square miles, compared to around 2,000 connected devices per 0.38 square miles with 4G. 5G technology aims to achieve this density by using small cell wireless network access points. The base stations for such small cells need to include industrial grade compute (CPU and GPU) capabilities as well as local storage/caching capabilities in order to fulfill the promise of very low latency response times provided by the 5G network. In prior implementations, base stations typically only contained a radio access network (RAN) interface as well as some form of data backhaul (either wireless or fixed wireline) to a central office (CO) of the telephone carrier operating those base stations.

In 5G, by far the most spectral bandwidth is available at the higher radio frequencies (in the so called “mm-Wave” spectrum bands). At those high frequencies, electromagnetic waves cannot penetrate solid matter, which means that client devices connecting to such mm-Wave base stations need to have optical line-of-sight (LOS) to the base stations RAN antenna.

The result of the above requirements and characteristics is that 5G networks need to deploy small cell base stations at a much higher density (orders of magnitude higher) than for conventional mobile wireless networks. At the same time, one single company spending the required capital to build this infrastructure would lead to extremely slow deployment of new networks, monopolistic control of the networks and limited penetration

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The following discloses an apparatus, method and system for communicating data between a data source and a client in a cellular communication network that includes a plurality of macro cells controlled by a cellular communication network and a plurality of relay nodes with each relay node controlled by an entity independent from the cellular communication network. The method includes: receiving data from the data source in a relay node of the plurality of relay nodes; retransmitting the data from the relay node to the client; computing, in the relay node, a transaction having proof that the data was retransmitted from the relay node to the client; providing the transaction from the relay node to a transaction tracker; and receiving compensation for retransmitting the data from the relay node to the client, the compensation predicated on verification of the computed transaction.

One embodiment is evidenced by an apparatus for communicating data between a data source and a client in a cellular communication network that includes a plurality of macro cells controlled by a cellular communication network and a plurality of relay nodes with each relay node controlled by an entity independent from the cellular communication network. The apparatus includes a processor and a memory, communicatively coupled to the processor. The memory stores processor instructions including instructions for: receiving data from the data source in a relay node of the plurality of relay nodes; retransmitting the data from the relay node to the client; computing, in the relay node, a transaction having proof that the data was retransmitted from the relay node to the client; providing the transaction from the relay node to a transaction tracker; receiving compensation for retransmitting the data from the relay node to the client, the compensation predicated on verification of the computed transaction.

Another embodiment is evidenced by a system for communicating data between a data source and a client in a cellular communication network including a plurality of macro cells controlled by a cellular communication network. The system includes: a relay node, controlled by an entity independent from the cellular communications system, and a transaction tracker. The relay node includes: a 5 g compliant transceiver, for transceiving data with a plurality of transceivers according to a 5 g protocol; a modem, for transceiving the data with a carrier of the cellular communication network via an internet service provider; a secure operating system, including: an extension network manager. for managing the transceiving of data with the plurality of transceivers and the carrier; a cell utilization metric module, for monitoring and reporting the transceiving of the data with the plurality of transceivers and the carrier. The transaction tracker is communicatively coupled to the relay node and the carrier. The transaction tracker is configured to report the transceiving of the data of with the plurality of transceivers and the carrier to the carrier; generate a transaction, the transaction including a transaction record describing the transceiving of the data between the transceivers and the carrier; a transaction proof including proof that the data was transceived. The transaction tracker is also configured to provide the transaction record to the carrier, and to write the transaction proof to a blockchain.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram of one embodiment of a 5G extended enterprise network

FIG. 2 is a diagram illustrating primary use models for a 5G enterprise extension network

FIG. 3 is a diagram presenting a diagram of generalized elements of the 5G enterprise extension network;

FIG. 4 is a diagram illustrating one embodiment of operations for the transmittal of data from the data origin to a client;

FIG. 5 is a diagram illustrating the computation of the transaction proof;

FIG. 6 is a diagram of an exemplary transaction; and

FIG. 7 is a diagram depicting an exemplary computer system that could be used to implement processing elements of the 5G extended enterprise network.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

The systems and method disclosed herein support secure 5G services by non-telecom carrier service entities. The system and method incentivizes non-carrier related entities (individuals, small businesses and large enterprises) to purchase and self-install 5G small cells at their place of residence or business and get rewarded for providing access to the 5G network this way. The 5G small cell network provided in such a manner augments the telecom carrier's macro-cell Radio Access Network, which would typically run in lower frequency spectrum. Rewards are a function of various service characteristics of the small cell, such as (but not limited to) communication bandwidth, amount of data transferred, CPU/GPU utilization as well as storage utilization. Additional rewards may be provided proportional to the Quality of Service (QOS) provided by the small cell.

Blockchain technology is used to operate cryptographically provable small cell operations and receive rewards for doing so via programmable money stored on the blockchain. Such operations can provide network bandwidth and other services such as compute power and storage. This allows small scale infrastructure operators, individuals and business owners to deploy edge computing nodes that can join a 5G network, provide computation and get compensated in algorithmic tokens for performing work

Client devices accessing this available compute power and storage are charged a small fee for the usage of this infrastructure. The fee is proportional to the actual resources consumed. The system provides means to measure resource consumption accurately and in a manner that prevents fraud. Data on resource consumption may be shared with a mobile network provider (telecom carrier). Customers (i.e. entities who purchase and install the small cell) may provide connectivity to a carrier network either by utilizing bandwidth provided by a third party (e.g. their Internet Service Provider) or the carrier may provide such connectivity.

The system uses a combination of “tokenized fiat” currency for the ultimate rewards payable to participants and an underlying “utility token” implementation based on a blockchain smart contract crypto-token system.

### Architecture

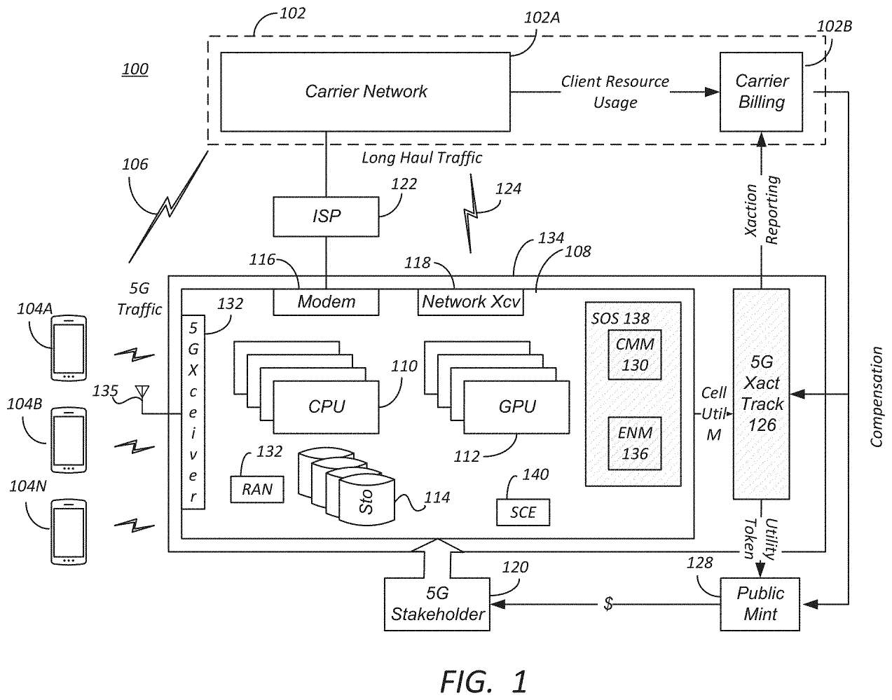

FIG. 1 is a diagram of one embodiment of a 5G extended enterprise network (EEN) 100. The EEN 100 comprises a cellular communications system or carrier 102, an extension network 134, one or more transceivers 104A-104N, a public mint 128, and a 5G stakeholder 120. The carrier 102 comprises entities such as VERIZON, T-MOBILE, or ATT. The carrier 102 includes a carrier network 102A and a carrier billing service/module 102B.

The carrier network 102A includes all of the elements required for mobile phone service including cellphone tower antennas, modems, and processing control elements needed to provide communications among transceiver stations 104A-104N (including equipment needed to communicate 5G, LTE and 3G protocols).

Although transceiver stations 104-104N (hereinafter alternatively referred to simply as transceiver(s) 104) are depicted as mobile transceivers, all of the transceivers 104 need not be mobile, as they may include land line elements of the public switched telephone network (PSTN). One or more of the transceivers 104 can communicate directly with the carrier network using the 5G protocol using 5G communications link 106 when disposed in locations sufficiently proximate to a 5G transceiver node of the carrier network 102A. However, for the reasons described above, there are many times a 5G transceiver node of the carrier network is not sufficiently proximate, and such communications are not possible using 5G.

In such instances, the extension network 134 may be used to permit 5G quality and throughput communications between the transceivers 104 and the carrier network 102A. The extension network 134 includes one or more enterprise extension modules (EEMs) 108, each communicatively coupled to a 5G transaction tracking module 126. Such EEMs 108 are provided (e.g. purchased, installed, maintained, and managed) by 5G stakeholders 120. The extension network is managed by an extension network manager (ENM) 136, which is a secure application executing in a secure operating system 138 of the EMM 108. The ENM 136 manages the execution of other secure applications executed by the secure operating system (SOS) 138, including applications for providing carrier 102 interface functionality (the management of communication with transceivers 104 including connection/disconnection with the extension network 134, managing communications traffic and spectrum allocation), the reward system. The EMM 108 may also include an open operating system section for future application development by third parties.

In one embodiment, the extension network 134 includes the 5G stakeholder 120. For example, an ENM 136 such as LIVE PLANET may manufacture or purchase EMMs 108 for installation at desired locations, and manage the use of the EMMs 108, providing 5G services to transceivers 104 of third parties, and being compensated for providing such services by the carrier 102. In another embodiment, the 5G stakeholder is external the extension network 134. In this example, the 5G stakeholder 120 may be an individual that purchases or rents EMMs 108 from LIVE PLANET for installation, and the 5G stakeholder 120 and LIVE PLANET share in the revenues derived from the carrier 102.

The EMMs 108 communicate with the transceivers 104 in locations where 5G service is unavailable by direct communication with the carrier network 102A. Such communications are provided by one or more 5G transceiver 132 in each EMM 108, as well as one or more 5G compatible antennas 135. The EMMs 108 augment the existing low/medium density 5G elements of the carrier network 102A of macro-cells with a very high density network of small cells, embodied by the EMMs 108.

In the illustrated embodiment, the EMMs 108 comprise one or more servers, each having one or more central processing units (CPUs) 110 and one or more graphical processing units (GPUs) 112. The CPUs HO perform a wide variety of processing tasks. Multiple CPUs 110 are provided to permit the concurrent processing of many tasks. The GPUs 112 permits concurrent rendering of high-resolution imaging and video information. Radio access network (RAN) 132 hardware and software are also provided by the EMMs 108. RAN 132 hardware/software implements the 5G a radio access technology. Conceptually, RAN 132 resides between a device such as a mobile phone, a computer, or any remotely controlled machine and provides connection with its core network. RAN 132 functionality is typically provided by a silicon chip residing in both the core network as well as the user equipment

The processing power provided by CPUs 110 and GPUs 112 permit the EMMs 108 to perform the edge processing required in a substantial portion of 5G communications. Instructions for performing the EMM processing, as well the information upon which the processing is performed are stored in memory 114. For example, memory 114 can be used to buffer data transmitted between the transceivers 104 and the carrier network, to perform edge computing of that data, as well as store the instructions required for such processing. Each EMM 108 effectively operates as a small cell, with a modular, configurable, and therefore scalable processing (CPU/GPU) capability and storage capacity.

Each EMM 108 also comprises one or more means for communicating with the carrier network 102A. Such communications may be accomplished via an internet service provider (ISP) 112 by a wired, optical, or wireless communications link. Such communications are provided by a modem 116 appropriate for the communications link (e.g. a DSL or cable modem). In the alternative or in addition to communications via the ISP 122, the EMM may communicate directly with the carrier network 102 by wired or wireless communications link 124 via one or more network transceivers 118. For example, such communications may be accomplished via 5G communications directly with the carrier network 102A, as the EMMs 108 may be advantageously placed to permit 5G communications with the carrier network 102A while the transceivers 104 are no so disposed. Such communications typically includes “long haul traffic,” e.g. communications traffic that is characterized by having high priority data, more stringent performance requirements (e.g. quality of service, or QoS), longer distances between nodes or endpoints and/or higher traffic volumes and densities. The carrier network 102 communicates data received from the transceivers 104 to other transceivers 104 or other elements external to the carrier network 102A, and similarly provides communications from such destinations to the transceivers 104 as desired. Such communications between the carrier network 102 and the transceivers 104 via the EMM 108 is typically two-way and full duplex.

The EMMs 108 are managed by an SOS 138 within the operating system used to manage the CPUs 110 of the EMM 108. The SOS 138 is used to securely operate a cell utilization metric module (CMM) 130 and an extension network manager (ENM) 136.

The CMM 130 monitors the provision of data and services between transceivers 104 and the carrier network 102 via the EMM 108, and provide such data to a 5G transaction tracking module 126. Such utilization metrics include, for example: QoS, throughput, latency, priority, connection speed, time of day and/or week. The 5G transaction tracking module accepts the utilization metrics and generates a transaction record that describes the transceiver 104 that utilized the EMM 108 to transceive information, what services were provided (e.g. the utilization metrics for the transaction, and other information in order that a fee amount can be calculated for the transaction. Typically, transaction data includes data for a single transaction between the EMM 108 and the transceiver 104A, with a transaction being defined as the time period between establishing a session between the transceiver 104 and the endpoint and the end of that session (e.g., a streaming session). In other embodiments, transactions are defined in terms of data objects (e.g. a transaction may be the transfer of a particular movie to a transceiver). The 5G transaction module also transmits a utility token to a public mint 128.

The transaction record is transmitted to a carrier billing module 102B. The carrier billing module 102B accepts the transaction record, and uses the information therein to compute a fee due to the 5G Stakeholder 120 for the data service provided by the EMM 108. That fee amount is deposited in a public mint 128, where it can be retrieved by the 5G stoker 120 using a utility token provided by the 5G transaction tracking module 126.

The carrier billing service 102B accepts client (e.g. transceiver 104) resource usage and provides this resource usage to the carrier billing service 102B. This resource usage includes, for example, the baseline subscription fee for transceiver 104A use, data transfer fees (e.g. number of MB of data transceived by the transceiver 104 using the carrier network), toll calls and the like. The resource usage may be tiered according to service levels or other factors, such as time of day and/or the presence of competing nodes for service. For example, high QoS services (high availability, high throughput) or other high tier services may be billed at different rates than lower tiered services. Further, in instances where there are competing transceivers 104 requesting client resources, and insufficient client resources are available to service both transceivers 104, the carrier billing service may adaptively price the use of the client resources accordingly.

The carrier 102 provides ultimate monetization based on metered/verified EMM 108 (small cell) usage by customers of the carrier 102. The carrier 102 also provides spectrum (e.g. allocates frequency bandwidth regimes to be available for use) to the EMMs 108. Different frequency regimes may be allocated to EMMs 108 owned by different 5G stakeholders 120 serving overlapping small cells. The carrier 102 also provides communication to and from destinations desired by the transceivers 104 (for example, providing communications between the transceivers 104 and the cloud or Internet. If the transceivers 104 require only Internet connectivity with a third party entity (e.g. to a website or video streamer), the EMM 108 may simply establish that Internet connectivity through its own ISP 122 without resort to the carrier network 102A, but even in this case, the carrier 102 bills the user of the transceiver 104 for the service provided and provides a share of this revenue to the 5G stakeholder 120 of the EMM 108. As less is required of the carrier 102, the 5G stakeholder 120 may be provided with a larger percentage of fees derived from this service. Carriers 102 may market the extended 5G service to their customers.

### Secure Cryptographic Enclaves

It is also useful meter computations performed in the EMM 108 as well as data transmitted through the EMM 108. This is performed in secure computational enclaves (SCE) 140. An SCE 140 is a computational environment where a computation can be cryptographically proven to have occurred. Such SCEs 140 include, for example, hardware processor enclaves such as SGX, available from INTEL, which allow user-level code to allocate private regions of memory (SCEs) which are designed to be protected from processes running at higher privilege levels. Further, when a computation is performed inside an SCE 140, the output is accompanied by a proof that is signed with a private key of the SCE 140 which can be verified by use of the public key associated with the private key. As described below, this is typically accomplished by generating a hash or other cryptographic function of the output, and encrypting that hash with the SCE's private key (also known as the signing key). The output, along with the encrypted hash, the SCE's public key (also known as the verifying key), and a description of the hash algorithm used to generate the hash is transmitted to the recipient. The recipient decrypts the hash using the provided SCE public key, generates its own hash of the output (using the indicated hash algorithm), and compares the two hashes. If they are equal, it is assured that the message was not altered in transmission. If the public and private key of the SCE were provided by a certificate authority (CA), that the message itself was sent by the SCE can also be verified.

### Use Models

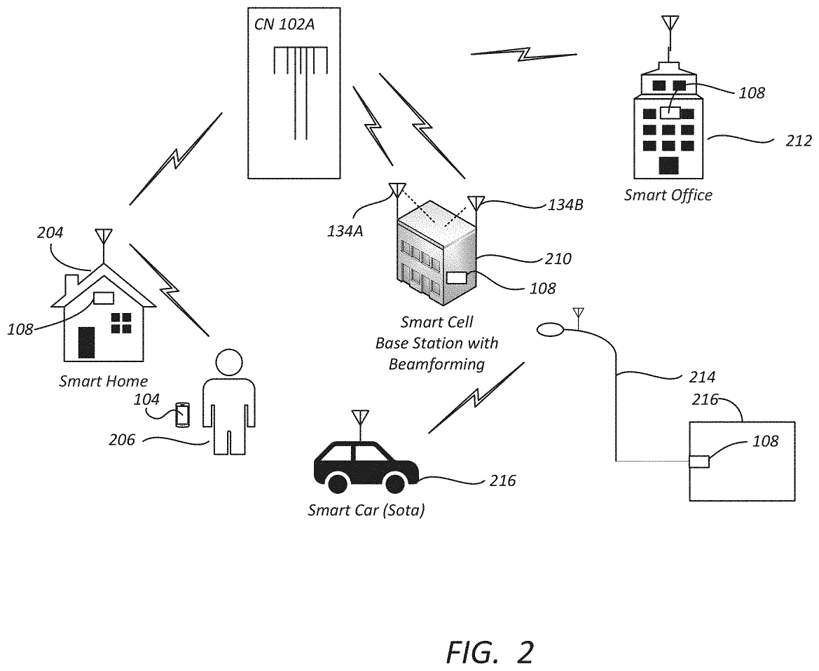

FIG. 2 is a diagram illustrating primary use models for a 5G enterprise extension network 100. A private use case involves the deployment of an EMM 108 in private/non-public entities such as enterprises, or residences, such as an individual's home 204. In this use case, all clients (e.g. transceivers 104) are known apriori (that is, before services are provided by the EMM 108). Typically, clients are members of a private entity such as a family or employees of a business. In this case, the provision of services by the EMM 108 is monetized through a direct relationship with the ENM 136.

An individual 206 who cannot transceive 5G services with the carrier network 102A directly instead establishes a session with the EMM 108 deployed at the home 204. That EMM 108 then establishes communications with the carrier network 102A, transceiving information between the carrier network 102A and the transceiver 104, and a record is made of this transaction. The user 206 may then be billed directly by the extension network 134 for the provision of such services. Alternatively, the user may be billed by the carrier 102 for this service, and at least a portion of the revenue from the user's payment is provided to the 5G stakeholder 120. Typically, this is the entity that owns the home 204 or the rights to install the EMM 108, but it may include an entity that has contracted with the entity that owns or controls the home 204. Furthermore, a revenue sharing agreement may be established between the homeowner and a third party 5G stakeholder 120, with that third party 5G stakeholder 120 providing a percentage of revenue derived from the provision of service to the homeowner. Non transactional billing (wherein a monthly fee for services is applied) is also envisioned.

A semi-private use case involves the deployment of the EMM 108 in publicly accessible, but privately owned facilities 210, 212 (e.g. sports venues, concert halls, shopping malls, cinemas, location based entertainment/virtual reality facilities, or office buildings). In this instance, some apriori knowledge of the clients using the EMMs 108 is possible. For example, a sports venue typically includes customers who have purchased season seats, and such customers can be identified apriori. In another example, a movie theater may have a “frequent viewer” program, with those individuals identified apriori. In this use case, the clients are customers of the venue, and monetization is accomplished via a relationship between the EMM 108 and the venue. In such cases, one or more EMMs 108 can be implemented, each having one or more antennas 134A and 134B to permit communication with transceivers 104 within a facility 210 by use of beamforming techniques or by use of repeaters or similar devices in the facility 210.

A public use case involves EMMs 108 installed in public places, for example, attached to public light fixtures 214. In this case, there is no apriori knowledge of the clients 216 accessing the EMM 108, and the clients are customers of their mobile carrier 102. In this case, monetization is accomplished via agreement (e.g. contractual relationship) with the carrier 102.

### Proof of Carrying Data

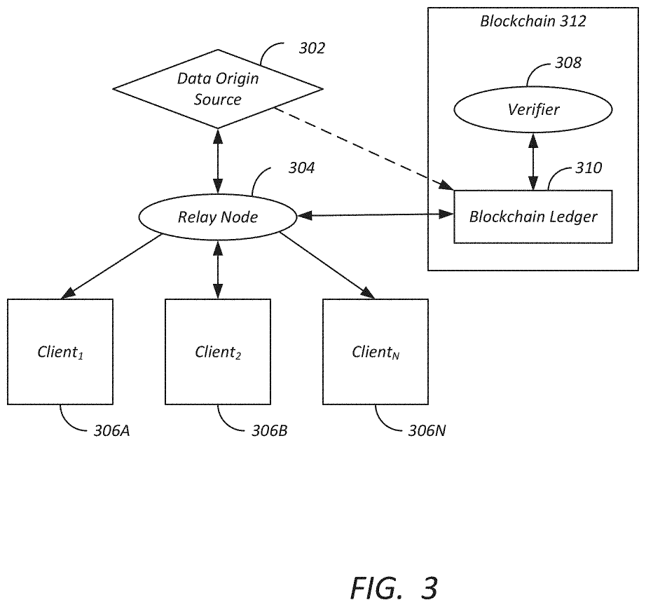

The 5G enterprise extension network 100 relies on the ability to prove that data was actually carried by the EMM 108 to assure that the 5G stakeholder 120 is properly compensated for use of the EMM 108 to carry data. This is referred to hereinafter as a transaction, which includes proof of carrying data (PoCD). The elements of the 5G enterprise extension network 100 can be generalized to five entities, as shown in FIG. 3.

The data origin 302 is the originator of the data intended to be delivered. This could be the carrier 102 if the data is to be delivered to the transceiver 104, or the transceiver 104 if data from that transceiver is to be sent to another transceiver 104, the carrier 102 or other entity. The relay 304 is a bidirectional relay (such as the EMMs 108) which relay data, preferably in a full duplex mode. The data client 306 is the entity that consumes or produces the data, for example, one of the transceivers 104. The blockchain 312 includes a blockchain distributed ledger 310 that records and establishes proof of carrying data for the data originators 302. The verifier 308 checks to determine if the reported data transfer (by the EMM 108) was in fact performed and accurate by performing an operation on the blockchain 312 that establishes the veracity of an operation.

### Cryptographic Setup for Blockchain Operators

Every operator of the EEN 100 has a set of keys that are generated for blockchain operations for security and verification purposes. In one embodiment, asymmetric or public key cryptography is used. In such asymmetric cryptography, key pairs (having a private key and a public key) are generated or otherwise obtained by each entity wanting to communicate data. The entities then exchange public keys, but keep their private keys secret. Any entity wishing to communicate with another entity encrypts the message with the intended recipient's public key. This encrypted message is decryptable only with the recipient's private key. Private keys can also be used to “sign” a transaction to allow the recipient to authenticate that the transaction was not altered in transmission and was received from the entity that purported to send the message. The entity creating the transaction signs the transaction (or message containing the transaction) using their private key (for example, by encrypting the transaction and including the encrypted transaction with the message. The recipient can verify that the transaction has not been altered by using the sender's public key to decrypt the encrypted transaction and compare it to the transaction itself. If the two are not the same, the transaction can be assumed to have been compromised in transmission. Similarly, hashes of the transaction can be encrypted by the sender's private key, and the recipient can decrypt the hash and compare that decrypted hash to a hash of the message generated by the recipient. Accordingly, a private key of the sender is used to “sign” the transaction, and the public key of the recipient is used to verify the transaction. The public key is commonly known as an “Account.”

### Secure Communications Between Origin and Relay

In a preferred embodiment, communications between the data origin 302 and the relay 304 are secured by encryption. Secure Sockets Layer (SSL) is one technique for establishing a secure connection between the data origin 302 and the relay node 304, and provides PrivateKey_{Origin}, PublicKey_{Origin}, PrivateKey_{Relay}, and PublicKey_{Relay}.

### Data Reception and Retransmission

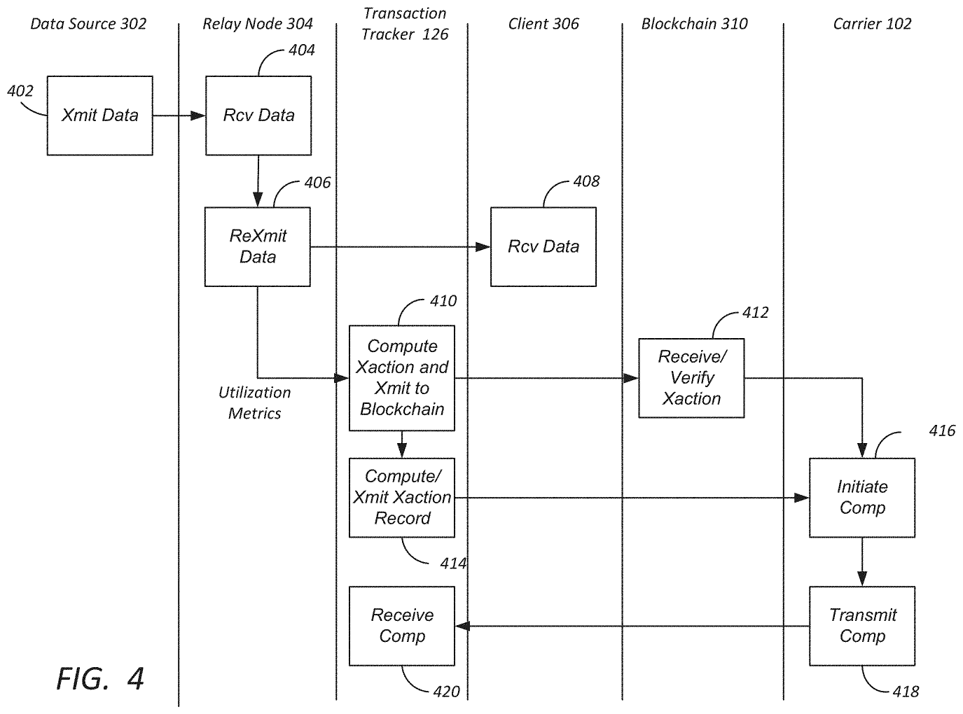

FIG. 4 is a diagram illustrating one embodiment of operations for reception and retransmission (transception) the transmittal of data from an the data origin 302 to a client 306. Transmitting data from the client 306 to the origin 302 is implemented by reversing these operations.

The data source/origin 302 (for example, carrier 102) desires to send a data packet that needs to be relayed to the client 306. The carrier 102 queries a list of relay nodes 304 available within the range of the client 306. This list is populated with the location of the relay nodes 304 (e.g. EMMs 108), which is compiled from information provided by the relay nodes 304 themselves or the ENM 136. Based upon this query, the data origin 302 selects the appropriate relay node 304, and sends the packet to the relay node 304, preferably, via a secure channel such as a secure sockets layer (SSL) communications channel via ISP 122. This is shown in block 402.

The relay node 304 receives the data packet, as shown in block 404. The relay node 304 then computes a ReceiptProof as proof that it received the data. The relay node 304 then forwards or retransmits the packet to the client 306, as shown in block 406, and the client receives the data, as shown in block 408. The relay node 304 then computes a TransmissionProof as proof that the data was transmitted to the client 306.

The transaction proof provides proof that the data was received and retransmitted from the relay node to the client, and it comprises the PoCD which is formed from the ReceiptProof and the TransmissionProof.

The relay node 304 then computes a transaction and writes the transaction to the blockchain ledger 310, as shown in block 410. This transaction includes a transaction proof (generated from the ReceiptProof and the TransmissionProof, as further described below). The blockchain 312 receives the transaction from the relay node 304, and a verifier 308 of the blockchain 312 attempts to verify the PoCD entry in the blockchain ledger 310, as shown in block 412 and described further below.

The relay node 304 also computes a transaction record for the transaction, and forwards the transaction record to the carrier, as shown in block 414. The carrier 102 uses the transaction record to identify the transaction written to the blockchain ledger 310, and uses the verifier 308 to verify the transaction. This permits the 5G stakeholder 120 of the relay node 304 to be compensated via a token transaction.

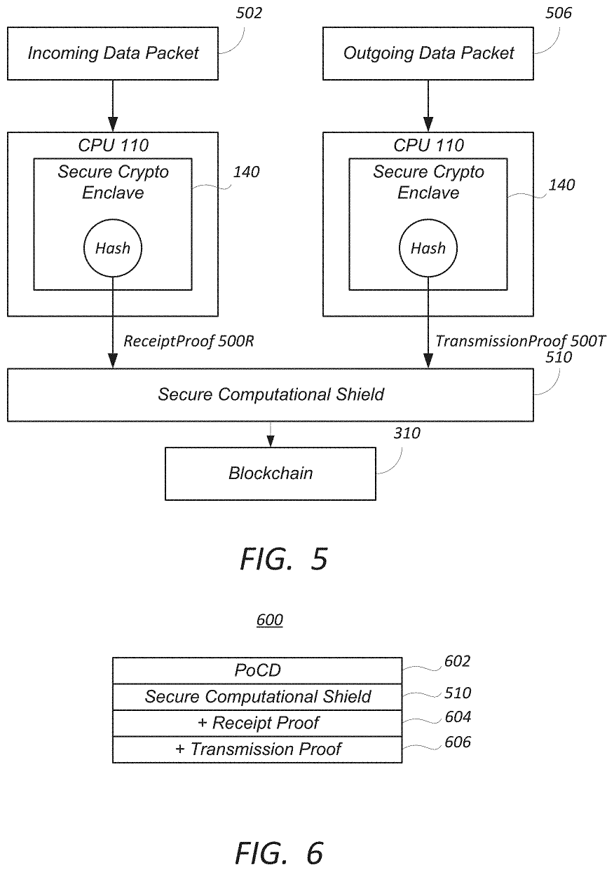

FIG. 5 is a diagram illustrating the computation of the transaction proof or PoCD. When an incoming packet 502 is received by the relay node 304, a hash (e.g. SHA526) or other cryptographic result is calculated for the entire data packet inside the SCE 140. The hash is then appended with computational proof from the SCE 140 (SCE Proof), and the combination is signed by the SCE's private key SCEPiK to form the ReceiptProof 500R.

The SCE proof is a computational proof that may be implemented in hardware or software. When a piece of code is executed in a “verifiable compute” environment, the input and the output of the execution of that code is passed through a circuit that outputs a hash-like signature that corresponds to the input and the output (for example, a hash of a concatenated combination of the input and output), and signs it with a private (signing) key of the processor, resulting in an encrypted hash. This result can be verified by providing the input and output as well as the encrypted hash to an attestation server that verifies the signature (e.g. decrypting the encrypted hash using the public key of the processor, and comparing the result to an attestation server-generated hash of the input and output). An example of commercially available products that provides a computational proof is INTEL's SGX system and a processor complying with the TinyRAM architecture specification (“TinyRAM Architecture Specification, v0.991,” SCIPR Lab, published Aug. 14, 2013, which is hereby incorporated by reference).

The signing operation is a matter of taking the hash of the data packet, appending it with the SCE Proof, then encrypting the result with the SCE's private key. Hence, the ReceiptProof 500R comprises a hash of the received data computed in an SCE 140 of the relay node 304 appended with a first computational proof, signed by the private key of the SCE 140, or:

ReceiptProof=Sign_{SCEPiK}(HASH(dataPacket)|SCEProof)

When the outgoing data packet 506 is forwarded by the relay node 304, the data packet 506 to be transmitted is hashed by the same hash function in the SCE 140, the hash is appended with a second computational proof from the SCE 140, and the combination is signed by the SCE's private key SCEPiK to form the TransmissionProof. Hence, the TransmissionProof 500T comprises a hash of the retransmitted data computed in the SCE 140 of the relay node 304 appended with the second computational proof, signed by the private key of the SCE 140.

TransmissionProof=Sign_{SCEPiK}(HASH(dataPacket)|SCEProof)

FIG. 6 is a diagram of an exemplary transaction 600. The transaction 600 includes the PoCD 602, in a Secure Computational Shield (SCS) 510 data structure that includes two fields: a first field 604 having the ReceiptProof 500R and a second field 606 having the TransmissionProof 500T.

Returning to FIG. 4, the verifier 308 of the blockchain 312 attempts to verify the PoCD of the transaction written to the blockchain ledger 310. This is accomplished by verifying the signature (by the SCE 140) of the ReceiptProof, verifying the signature of the TransmissionProof, comparing the hashes of the data packets, and verifying the transaction if the hash of the received data packet matches the hash of the transmitted data packet.

Returning to FIG. 4, after the carrier 102 receives the transaction record from the relay node 304, the carrier 102 uses information identifying the transaction in the transaction record to obtain the verified transaction proof from the blockchain 312. Based upon this verified transaction proof, the carrier 102 initiates providing compensation to the transaction tracker 126, as shown in block 416. In one embodiment, this is accomplished by making an electronic deposit in a public mint 128, and providing the 5G Transaction tracker 126 a record of the deposit. Compensation is transmitted in block 418, and in block 420, the 5G Transaction tracker 126 receives the record and generates a utility token, which permits the 5G stakeholder 120 to recover their portion of the provided compensation.

Utility tokens are data structures in the blockchain that provide a functionality analogous to that of a counter. When a token is received by an entity, it indicates that the blockchain has had a transaction (e.g. a blockchain transaction) that incremented the token. In the above examples, the EMM 108 receives a data packet, and retransmits the data packet. The EMM 108 then submits proof that the data packet was transmitted to the blockchain, and the blockchain issues a utility token that is provided to the EMM 108 via the transaction tracker 126.

In this application, a transaction is made for every successful data packet transmission using the EMM 108. When a transaction is made, these tokens increase in number, and each token is tied to a form of currency such as a United States dollar. When money is to be withdrawn, a corresponding withdrawal transaction is made.

### Hardware Environment

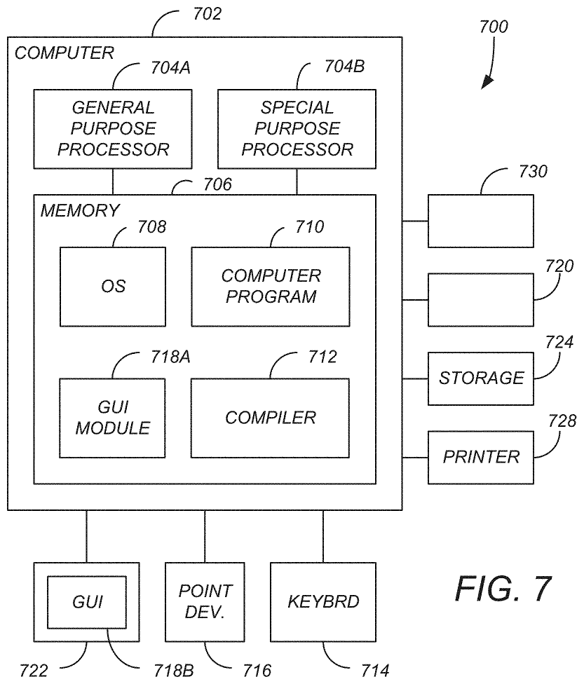

FIG. 7 illustrates an exemplary computer system 700 that could be used to implement processing elements of the above disclosure, including the EMM 108, transceivers 104, transaction tracker 126, and portions of the carrier network 102. The computer 702 comprises one or more processors 704 including general purpose processor 704A and special purpose processor 704B (for example, a secure processor used to implement the SCE 140 and a memory, such as random access memory (RAM) 706. The computer 702 is operatively coupled to a display 722, which presents images such as windows to the user on a graphical user interface 718B. The computer 702 may be coupled to other devices, such as a keyboard 714, a mouse device 716, a printer 728, etc. Of course, those skilled in the art will recognize that any combination of the above components, or any number of different components, peripherals, and other devices, may be used with the computer 702.

Generally, the computer 702 operates under control of an operating system 708 stored in the memory 706, and interfaces with the user to accept inputs and commands and to present results through a graphical user interface (GUI) module 718A. Although the GUI module 718B is depicted as a separate module, the instructions performing the GUI functions can be resident or distributed in the operating system 708, the computer program 710, or implemented with special purpose memory and processors. The computer 702 also implements a compiler 712 which allows an application program 710 written in a programming language such as COBOL, C++, FORTRAN, or other language to be translated into processor 704 readable code. After completion, the application 710 accesses and manipulates data stored in the memory 706 of the computer 702 using the relationships and logic that was generated using the compiler 712. The computer 702 also optionally comprises an external communication device such as a modem, satellite link, Ethernet card, or other device for communicating with other computers.

In one embodiment, instructions implementing the operating system 708, the computer program 710, and the compiler 712 are tangibly embodied in a computer-readable medium, e.g., data storage device 720, which could include one or more fixed or removable data storage devices, such as a zip drive, floppy disc drive 724, hard drive, CD-ROM drive, tape drive, etc. Further, the operating system 708 and the computer program 710 are comprised of instructions which, when read and executed by the computer 702, causes the computer 702 to perform the operations herein described. Computer program 710 and/or operating instructions may also be tangibly embodied in memory 706 and/or data communications devices 730, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### CONCLUSION

This concludes the description of the preferred embodiments of the present disclosure.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of communicating data between a data source and a client in a cellular communication network comprising a plurality of macro cells controlled by a cellular communication network, and a plurality of relay nodes, each relay node controlled by an entity independent from the cellular communication network the method comprising:
receiving data from the data source in a relay node of the plurality of relay nodes;
retransmitting the data from the relay node to the client;
computing, in the relay node, a transaction having proof that the data was retransmitted from the relay node to the client;
providing the transaction from the relay node to a transaction tracker; and
receiving compensation for retransmitting the data from the relay node to the client, the compensation predicated on verification of the computed transaction.

2. The method of claim 1, wherein the transaction comprises a proof of receipt and a proof of transmission.

3. The method of claim 2, wherein:
the proof of receipt comprises a hash of the received data computed in a secure computational enclave of the relay node appended with a first computational proof; and
the proof of transmission comprises a hash of the retransmitted data computed in the secure computational enclave of the relay node appended with a second computational proof.

4. The method of claim 3, wherein:
the hash of received data is appended with computational proof is signed according to a public key of a secure computational enclave of the relay node; and
the hash of the retransmitted data is appended with computational proof is signed according to a public key of a secure computational enclave of the relay node.

5. The method of claim 4, wherein providing the transaction from the relay node to a transaction tracker comprises writing the transaction to a blockchain.

6. The method of claim 5, wherein a verifier verifies the transaction by:
verifying the signature of the proof of receipt;
verifying the signature of the proof of transmission;
comparing the hash of the received data with the hash of the transmitted data; and
verifying the computed transaction according to the comparison.

7. The method of claim 6, wherein compensation is provided via a blockchain transaction using a utility token of the blockchain.

8. The method of claim 7, wherein data comprises a data packet.

9. An apparatus for communicating data between a data source and a client in a cellular communication network comprising a plurality of macro cells controlled by a cellular communication network, and a plurality of relay nodes, each relay node controlled by an entity independent from the cellular communication network the apparatus comprising:
a processor;
a memory, communicatively coupled to the processor, the memory storing instructions comprising instructions for:
receiving data from the data source in a relay node of the plurality of relay nodes;
retransmitting the data from the relay node to the client;
computing, in the relay node, a transaction having proof that the data was retransmitted from the relay node to the client;
providing the transaction from the relay node to a transaction tracker; and
receiving compensation for retransmitting the data from the relay node to the client, the compensation predicated on verification of the computed transaction.

10. The apparatus of claim 9, wherein the transaction comprises a proof of receipt and a proof of transmission.

11. The apparatus of claim 10, wherein:
the proof of receipt comprises a hash of the received data computed in a secure computational enclave of the relay node appended with a first computational proof; and
the proof of transmission comprises a hash of the retransmitted data computed in the secure computational enclave of the relay node appended with a second computational proof.

12. The apparatus of claim 11, wherein:
the hash of received data is appended with computational proof is signed according to a public key of a secure computational enclave of the relay node; and
the hash of the retransmitted data is appended with computational proof is signed according to a public key of a secure computational enclave of the relay node.

13. The apparatus of claim 12, wherein the instructions for providing the transaction from the relay node to a transaction tracker comprises instructions for writing the transaction to a blockchain.

14. The apparatus of claim 13, wherein the transaction is verified by:
verifying the signature of the proof of receipt;
verifying the signature of the proof of transmission;
comparing the hash of the received data with the hash of the transmitted data; and
verifying the computed transaction according to the comparison.

15. The apparatus of claim 14, wherein compensation is provided via a blockchain transaction using a utility token of the blockchain.

16. The apparatus of claim 15, wherein data comprises a data packet.

17. A system for communicating data between a data source and a client in a cellular communication network comprising a plurality of macro cells controlled by a cellular communication system comprising:
a relay node, controlled by an entity independent from the cellular communications system, the relay node comprising:
a 5G compliant transceiver, for transceiving data with a plurality of transceivers according to a 5G protocol;
a modem, for transceiving the data with a carrier of the cellular communication network via an internet service provider;
a secure operating system, comprising:
an extension network manager. for managing the transceiving of data with the plurality of transceivers and the carrier;
a cell utilization metric module, for monitoring and reporting the transceiving of the data with the plurality of transceivers and the carrier;
a transaction tracker, communicatively coupled to the relay node and the carrier, the transaction tracker for
reporting the transceiving of the data of with the plurality of transceivers and the carrier to the carrier;
generating a transaction, the transaction comprising
a transaction record describing the transceiving of the data between the transceivers and the carrier;
a transaction proof comprising proof that the data was transceived;
providing the transaction record to the carrier; and
writing the transaction proof to a blockchain.

18. The system of claim 17, wherein:
the blockchain comprises a verifier and a blockchain ledger;
the transaction proof is written to the blockchain ledger; and
the verifier verifies the transaction proof.

19. The system of claim 18, wherein:
the transceived data comprises received data and retransmitted data;
the transaction proof comprises:
a proof of receipt that proves that the data was received by the relay node, wherein the proof of receipt comprises a hash of the received data computed in a secure computational enclave of the relay node appended with a first computational proof; and
a proof of transmission that proves that the received data was retransmitted by the relay node, wherein the proof of transmission comprises a hash of the retransmitted data computed in the secure computational enclave of the relay node appended with a second computational proof.

20. The system of claim 19, wherein
the hash of received data is appended with computational proof is signed according to a public key of a secure computational enclave of the relay node; and
the hash of the retransmitted data is appended with computational proof is signed according to a public key of a secure computational enclave of the relay node.
